(19) United States
(12) Patent Application Publication
(10) Pub. No.: US 2006/0207050 A1
(43) Pub. Date: Sep. 21, 2006

(54) Windshield wiper structure

(76) Inventors: Subramaniam Shanmugham, Aledo, TX (US); Zhi-Ming Yang, Taipei City (TW); Chuan-Zhi Chang, Taipei City (TW); Gerhard Heyner, Storkow (DE)

Correspondence Address: PATTON BOGGS, L.L.P., 2001 ROSS AVENUE, SUITE 3000, DALLAS, TX, 75201, US

(21) Appl. No.: 11/192,714

(22) Filed: Jul. 29, 2005

(30) Foreign Application Priority Data
Jul. 30, 2004 (CN) 93212160
Aug. 13, 2004 (CN) 200420074056.3

(51) Int. Cl. B60S 1/38; B60S 1/40

(52) U.S. Cl. 15/250.43; 15/250.32; 15/250.201

(57) ABSTRACT

A windshield wiper structure includes a supporting member, a connection bracket straddled on a predetermined surface of the supporting member, and a wiper strip engaged with the supporting member. The supporting member includes two elongated arc sheets parallel to each other. The connection bracket has a base, two parallel plates extending upwardly from two lateral sides of the base respectively, a bar over the base and connected between the two parallel plates, and a clip member extending inwardly from each lateral side of a bottom of the base in order to clasp the lower surface of the supporting member.

### CROSS-REFERENCE TO RELATED APPLICATIONS

This application claims the benefit of Chinese Patent Application No. 93212160 filed Jul. 30, 2004, which is hereby incorporated by reference.

### BACKGROUND OF THE INVENTION

1. Field of the Invention

The present invention relates to a windshield wiper, and particularly relates to a connection bracket adapted for pushing forward a wiper blade against the windshield, in order to scrape off rain or mud adhered thereto.

2. Description of Related Art

A wiper blade is used to abut against the windshield of a motor vehicle for scraping off rain or mud adhered thereto, so as to keep a clear, unobstructed view of the road for the driver. It is a critical safety concern that the wipers provide a good wiping capability to provide the cleanest windshield possible. A resilient, rubber wiper strip is provided to conform to the windshield tightly for effectively removing rain and other debris.

With respect to FIGS. 1 and 2, a conventional wiper blade is illustrated and includes a rubber wiper strip 10a abutting against a windshield 20a of a motor vehicle, a supporting member 30a being substantially elongated and rectangular, and a connection bracket 40a disposed on a middle portion of the supporting member 30a for connecting a U-shaped driving arm 50a. The wiper strip 10a includes a head portion 12a and a scrape portion 14a. The scrape portion 14a is an elongated strip having a triangular cross section. The scrape portion 14a has a rectangular recess 16a where the scrape portion 14a and the head portion 12a meet. The wiper strip 10a is connected to the supporting member 30a along a longitudinal line thereof. The connection bracket 40a has at least one flat surface adhered to the supporting member 30a.

The connection bracket 40a of a conventional wiper blade is only adapted for attachment to specialized driving arms and is not broadly adapted to allow connection to a variety of more common driving arms. Because of the various types of the driving arms, such as hook type, pivot type or insertion type, the wiper blade should be improved for further adaptability. In addition, the wiper strip 10 is configured with a triangular tip, and the recess 16a formed at the junction of the scrape portion 14a and the head portion 12a collects mud and rain scraped from the windshield. This buildup of moisture and debris within the recess 16a can freeze when the wiper is operated in lower temperatures, thereby reducing the wiping efficiency of the wiper strip 10.

### BRIEF SUMMARY OF THE INVENTION

A windshield wiper structure is provided for various types of driving arms and is provided with an improved connection bracket for attaching the wiper to the driving arms.

A windshield wiper structure is provided for being replaceable.

A windshield wiper structure includes a supporting member, a connection bracket straddled on a predetermined surface of the supporting member, and a wiper strip engaged with the supporting member. The supporting member includes two elongated arc sheets parallel to each other. The connection bracket has a base, two parallel plates extending upwardly from two lateral sides of the base respectively, a bar over the base and connected between the two parallel plates, and a clip member extending inwardly from each lateral side of a bottom of the base in order to clasp the lower surface of the supporting member.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a conventional wiper blade;

FIG. 2 is a cross-sectional profile of the conventional wiper blade;

FIG. 3 is an exploded perspective view of a windshield wiper structure according to an embodiment of the present invention, the windshield wiper structure including a wiper blade, a support member, and a connection bracket;

FIG. 4 is an enlarged perspective view of the connection bracket of FIG. 3;

FIG. 4A is an exploded perspective view of the connection bracket of FIG. 4;

FIG. 4B is an exploded perspective view of the connection bracket according to an embodiment of the present invention;

FIG. 5 is an assembled perspective view of the windshield wiper structure of FIG. 3;

FIG. 6 is a cross-sectional side view of the windshield wiper structure of FIG. 3 taken at VI-VI;

FIG. 7 is a perspective view of a wiper arm adapter according to an embodiment of the present invention;

FIG. 8 is a perspective view of a wiper arm adapter according to an embodiment of the present invention;

FIG. 9 is a perspective view of a wiper arm adapter according to an embodiment of the present invention;

FIG. 10 is a perspective view of a wiper arm adapter according to an embodiment of the present invention;

FIG. 11 is a perspective view of a wiper arm adapter according to an embodiment of the present invention;

FIG. 12 is a cross-sectional view of the wiper arm adapter of FIG. 11 taken at XII-XII;

FIG. 13 is a perspective view of the wiper arm adapter of FIG. 11 being used to connect a hook-type wiper arm to a windshield wiper structure according to an embodiment of the present invention;

FIG. 14 is a perspective view of the wiper arm adapter of FIG. 11 being used to connect a bayonet-type wiper arm to a windshield wiper structure according to an embodiment of the present invention;

FIG. 15 is a perspective view of the wiper arm adapter of FIG. 11 being used to connect a pin-type wiper arm to a windshield wiper structure according to an embodiment of the present invention; and

FIG. 16 is a perspective view of the wiper arm adapter of FIG. 11 being used to connect a pin-type wiper arm to a windshield wiper structure according to an embodiment of the present invention.

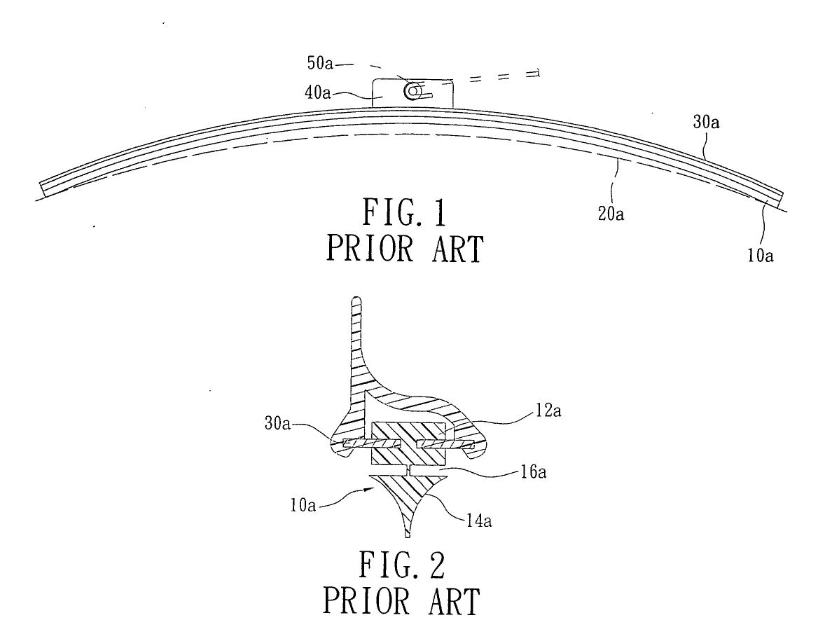

### DETAILED DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

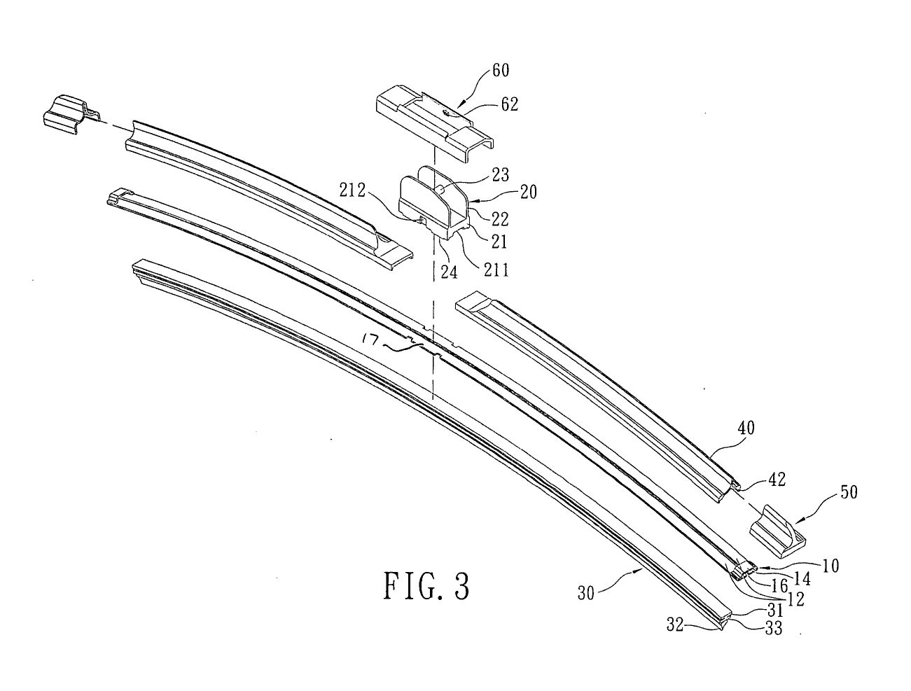

With respect to FIG. 3, a windshield wiper structure according to the present invention includes a supporting member 10, a connection bracket 20 straddled on an upper surface of the supporting member 10, and a wiper strip 30 engaged by the supporting member 10. The supporting member 10 includes two elongated arc sheets 12 parallel to each other, a guiding slot 16 formed between the two elongated arc sheets 12, and two secure members 14 disposed at two ends thereof respectively. Each secure member 14 connects the two elongated arc sheets 12 together for providing the supporting capability thereof. The two elongated sheets 12 may be formed from a material such as spring steel and formed such that the elongated sheets 12 are in a generally arcuate shape when no force is applied to the each elongated sheet 12. A windshield wiper utilizing arcuately formed supporting members 10 allows the wiper strip 30 to more closely match the contour of a windshield, even though bridges and other force application mechanisms associated with traditional wipers are not used.

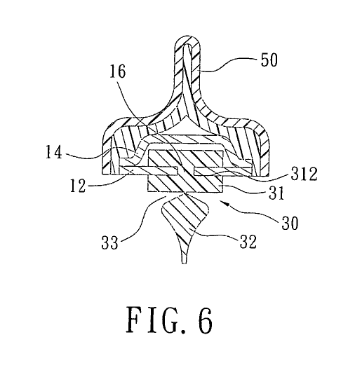

The supporting member 10 has a connection pad 17 on which the connection bracket 20 rests. An opposite, lower surface of the supporting member 10 rests against the wiper strip 30 when the windshield wiper structure is assembled. The connection bracket 20 has a base 21, two parallel plates 22 extending upwardly from two lateral sides of the base 21 respectively, a bar 23 over the base 21 and connected between the two parallel plates 22, and a clip member 24 extending inwardly from each lateral side of a bottom of the base 21 in order to clasp the lower surface of the supporting member 10. The wiper strip 30 has a head portion 31 and a wiping portion 32 connected to the head portion 31. The head portion 31 includes a gap 312 formed along each lateral side thereof for mating with the elongated sheets 12 of the supporting member 10 (see FIG. 6).

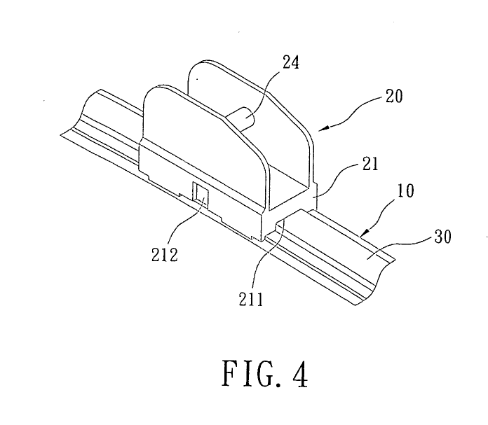

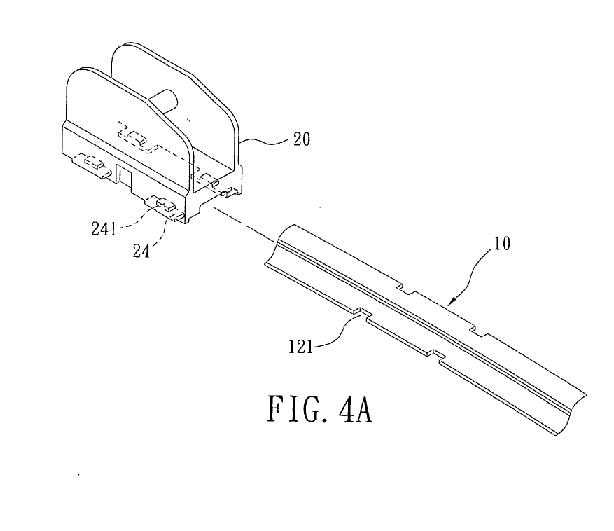

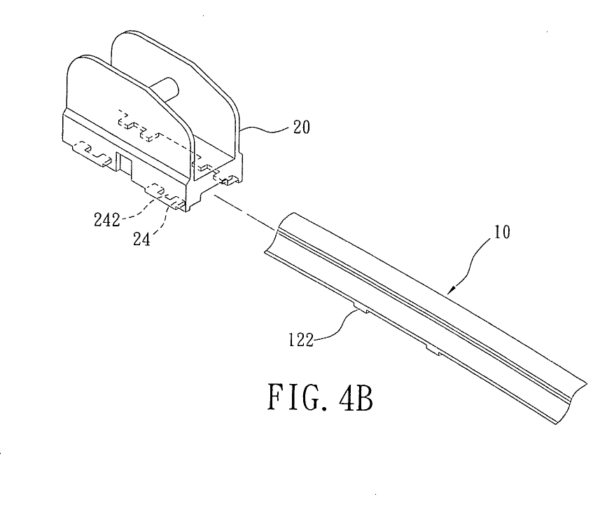

Referring to FIG. 4, the base 21 of the connection bracket 20 has an indentation 211 formed on the bottom thereof for mating with the head portion 31 of the wiper strip 30.

Referring to FIGS. 3 and 6, the wiping portion 32 of the wiper strip 30 is an elongated strip that has a generally tear-drop shape, so as to form a wedge notch 33 between the head portion 31 and the wiping portion 32. The shape of the wedge notch resists moisture buildup between the head portion 31 and the wiping portion 31, thereby preventing freezing of water and other debris within the wedge notch 33 at low temperatures.

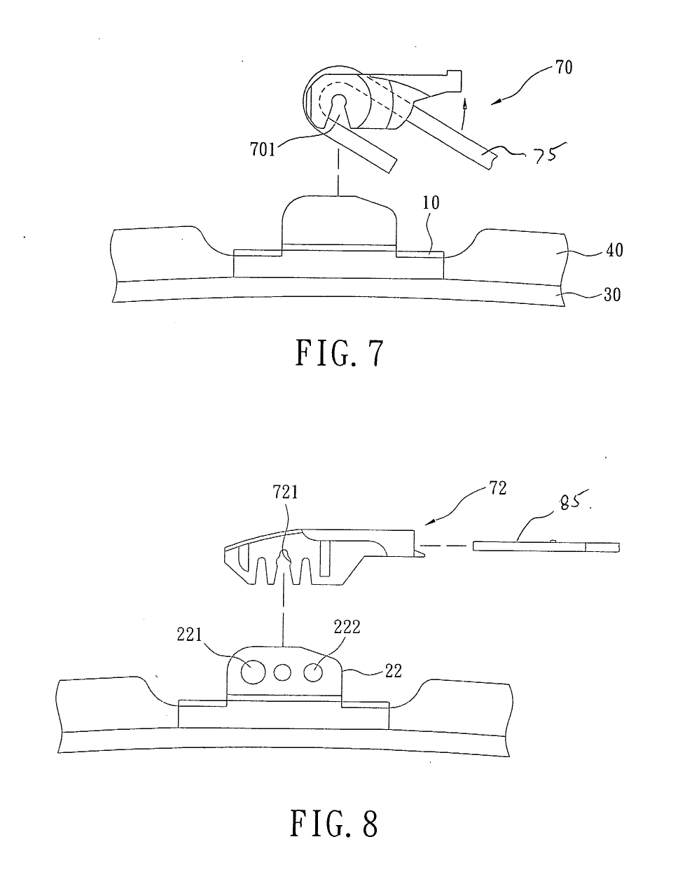

The bar 23 of the connection bracket 20 may be integrally connected to the two parallel plates 22 as illustrated in FIGS. 3 and 7. Alternatively, the bar 23 of the connection bracket may be detachable from the two parallel plates 22 as shown in FIGS. 8-10.

Referring to FIG. 4A, each of the supporting members 10 has a pair of indentations 121, and the clip member 24 of the connection bracket 20 includes a tab 241 that mates with the indentation 121 for securely connecting the connection bracket 20 to the supporting member 10. Alternatively, FIG. 4B illustrates another embodiment in which indentations 242 are disposed on the connection bracket 20 for mating with a pair of tabs 122 disposed on the lower surface of each supporting member 10.

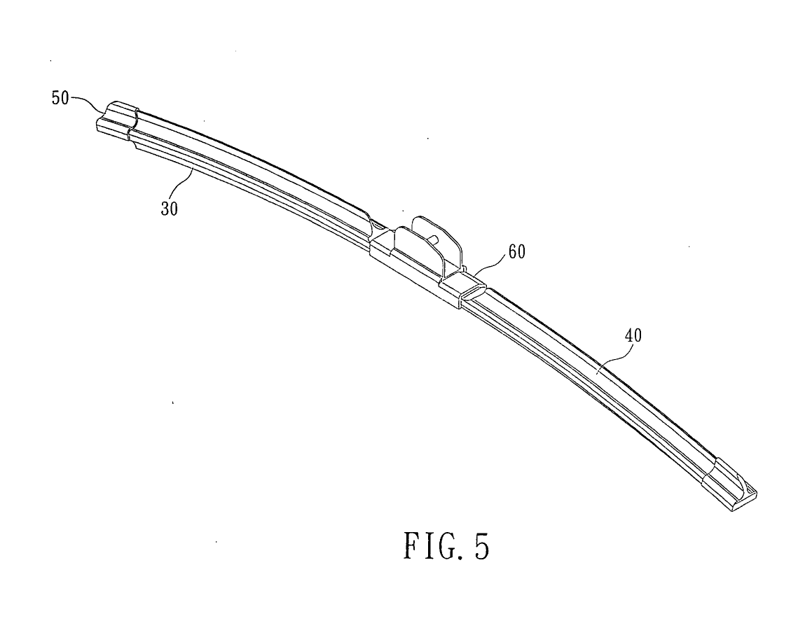

Referring to FIG. 5, the windshield wiper structure further includes a pair of resilient covers 40 positioned over the supporting members 10, each cover 40 being disposed adjacent opposing ends of the connection bracket 20. Each of the resilient covers 40 is fin-shaped to surround and protect the upper surfaces of the supporting members 10 and the head portion 31 of the wiper strip 30.

The windshield wiper structure further includes two end sleeves 50 disposed on each end of the supporting members 10. The end sleeves 50 engage and partially cover a portion of the covers 40 to securely fasten the covers 40 respectively to the supporting members 10. The end sleeves 50, like the covers 40, protect the wiper strip 30 and provide an aerodynamic upper surface for reducing drag against the windshield wiper structure during use and when installed on a vehicle. If the wiper strip 30 needs to be replaced, one or both of the sleeve portions 50 can be removed, thereby allowing the wiper strip 30 to be removed and replaced.

Referring FIGS. 3 and 5, the windshield wiper structure further includes a bracket cover 60 for protecting the connection bracket 30 and the two resilient strips 40 respectively. The base 21 of the connection bracket 30 includes a snap recess 212 formed on each lateral side thereof, and the cover member 60 has a snap tab 62 formed on an inner surface of each lateral side for mating with the snap recess 60 to provide a secure connection.

Referring to FIG. 7, a wiper adapter 70 is provided to allow connection of the windshield wiper structure to a wiper arm 75. The wiper adapter 70 has a first hinge hole 701 that mates with the bar 23 of the connection bracket 20. Once installed on the bar 23, the wiper adapter 70 allows the windshield wiper structure to pivot relative to the wiper arm 75. The wiper arm 75 is a hook-type arm, and wiper adapter 70 is designed to mate with this type of wiper arm.

Referring to FIGS. 8-10, each of the two parallel plates 22 of the connection bracket 20 has at least one through hole 221 (and further an additional through hole 222) for various applications. With respect to FIG. 8, a wiper adapter 72 is provided to allow connection of the windshield wiper structure to a wiper arm 85. The wiper adapter includes a hinge hole 721 that mates with the bar 23 of the connection bracket 20. Once installed on the bar 23, the wiper adapter 72 allows the windshield wiper structure to pivot relative to the wiper arm 85. The wiper arm 85 is a bayonet-type arm, and wiper adapter 80 is designed to mate with this type of wiper arm.

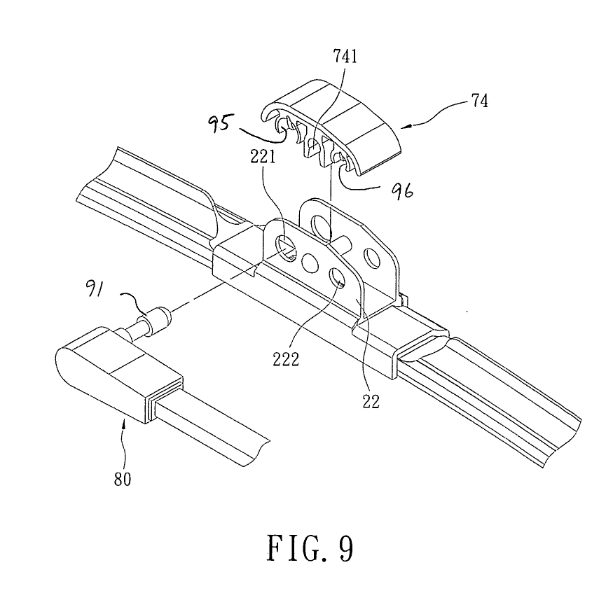

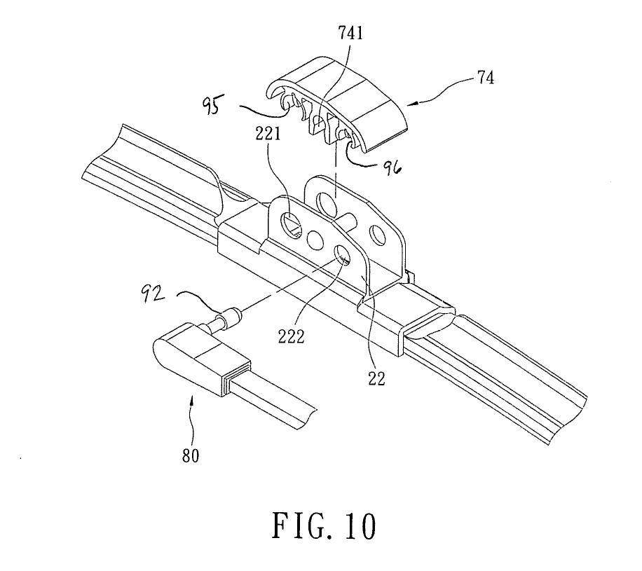

Referring more specifically to FIGS. 9 and 10, a wiper adapter 74 is provided to allow connection of the windshield wiper structure to a wiper arm 80. The wiper adapter includes a hinge hole 741 that mates with the bar 23 of the connection bracket 20. Once installed on the bar 23, the wiper adapter 74 allows the windshield wiper structure to pivot relative to the wiper arm 80. The wiper arm 80 is a pin-type arm and includes a pin 91, 92 for insertion through either hole 221 or hole 222 depending on the size of the pin. Once inserted through one of the holes 221, 222 in the connection bracket 20, the pin 91, 92 engages one of a pair of passages 95, 96 formed on the wiper adapter 74. The wiper adapter 74 is designed to mate with this type of wiper arm.

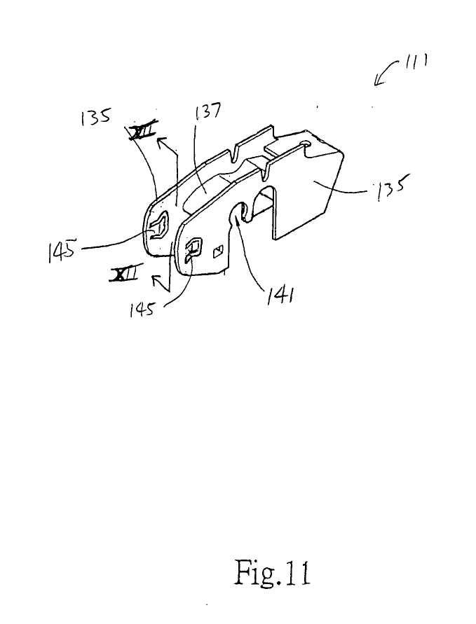

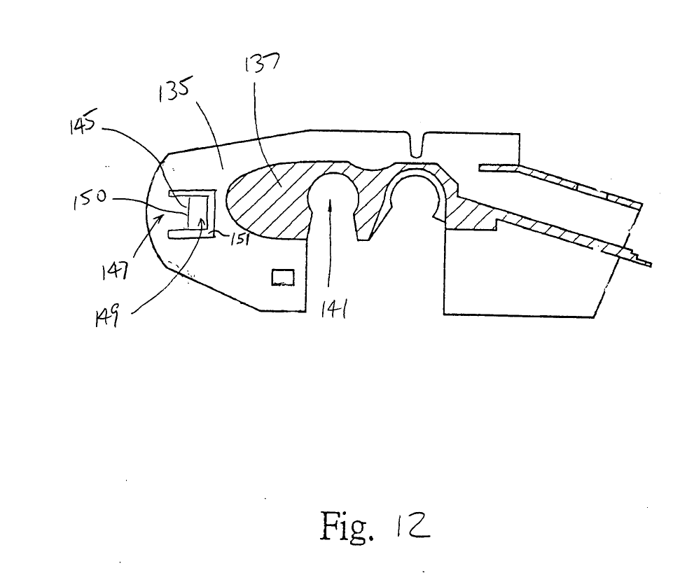

Referring to FIG. 11 and 12, a universal wiper adapter 111 may alternatively be used in place of the wiper adapters 70, 72, and 74 of FIGS. 7-10. Wiper adapter 111 is capable of being used with many different sizes, shapes, and types of wiper arms, including without limitation, hook arms, bayonet arms, and pin arms. Adapter 111 includes a pair of side panels 135 that are integrally joined by an arcuate transverse member 137. A fixed detent may be positioned on an inner surface of each side panel 135 to assist in securing a wiper arm to the wiper adapter 111. The wiper adapter 111 also includes a semi-cylindrical passage 141 that passes through the side panels 135 and arcuate transverse member 137. The passage 141 is sized to receive the bar 23 positioned on the connection bracket 20 (see FIG. 3). The mating engagement of the bar 23 within the passage 141 allows the adapter to be securely and pivotally connected to the windshield wiper structure.

Referring to both FIGS. 11 and 12, the wiper adapter 111 may include an inwardly biased tab 145 that is positioned on each of the side panels 135 to facilitate easier use of the wiper adapter 111 with hook-type wiper arms. The tab 145 includes a constrained region 147 and a free region 149 that project inward from the side panel 135 and intersect to form a retention ridge 150. A relief slot 151 surrounds a portion of the constrained region 147 and the free region 149. One portion of the constrained region 147 is integrally attached to the side panel 135. The relief slot 151 allows the constrained region 147 and free region 149 to “flatten” as a hook-type wiper arm 21 is installed on the wiper adapter 111. After the end of the wiper arm passes the retention ridge 150, the natural resiliency of the constrained region 147 and the free region 149 cause the retention ridge 150 to rebound inward, thereby securing the wiper arm and preventing it from becoming disengaged from the wiper adapter 111.

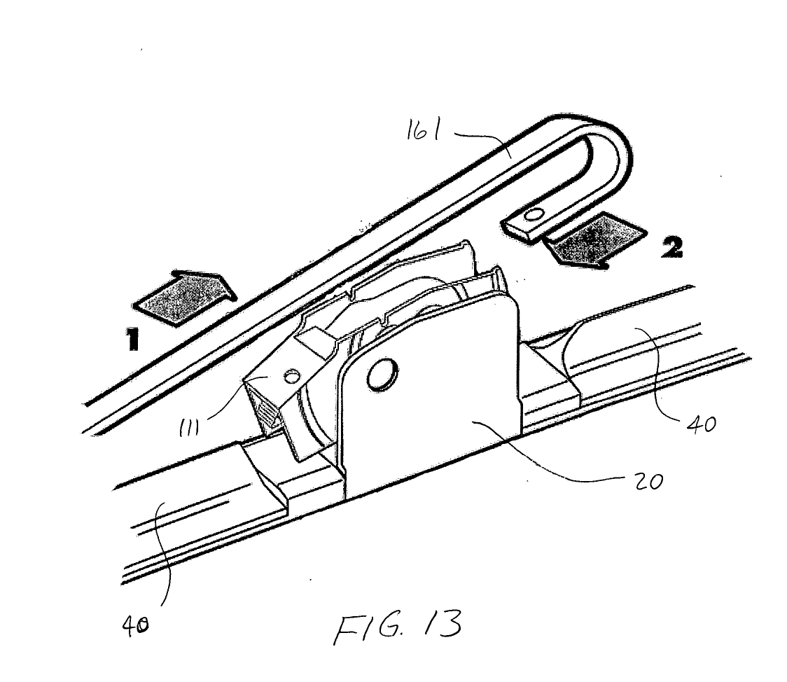

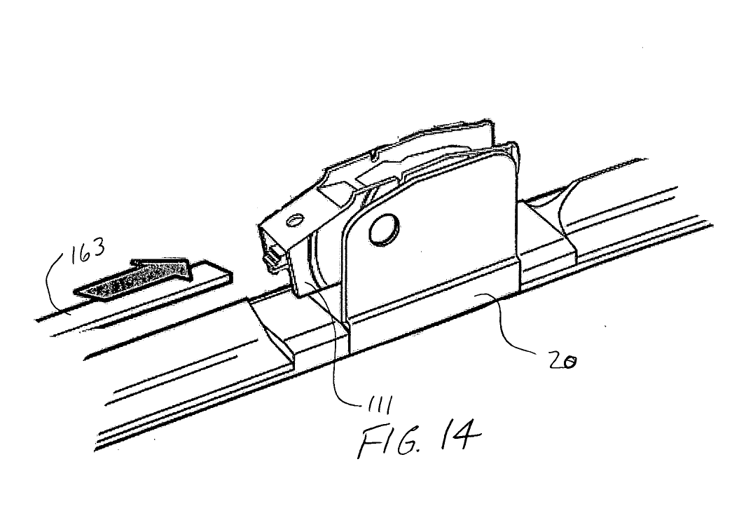

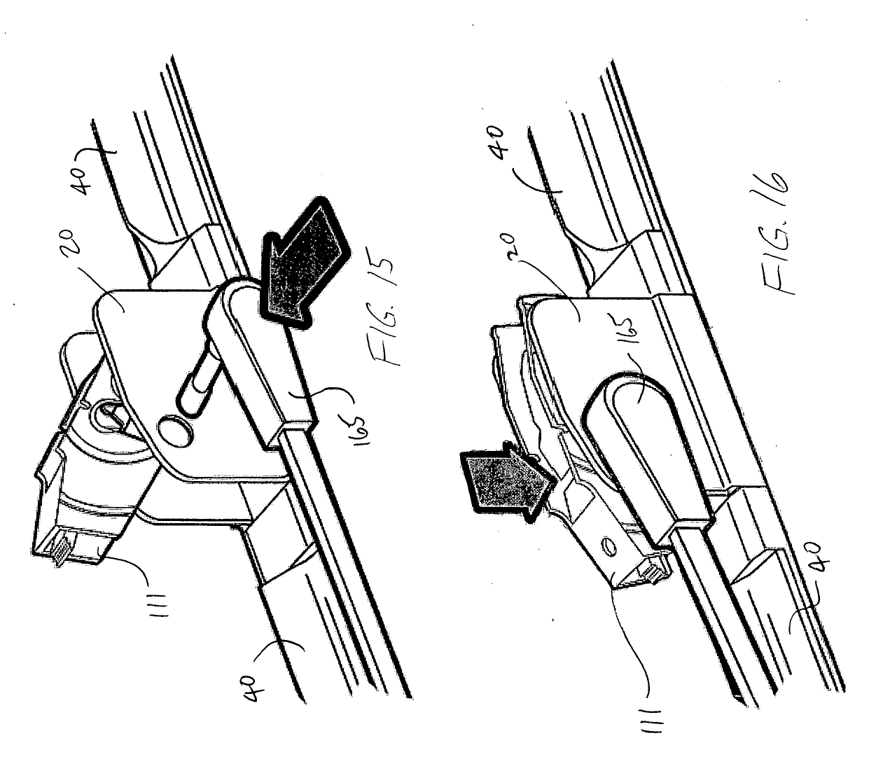

Referring to FIG. 13, wiper adapter 111 may be used to connect a hook-type wiper arm 161 to the windshield wiper structure. Alternatively, wiper adapter 111 may be used to connect a bayonet-type wiper arm 163 to the windshield wiper structure (see FIG. 14). The wiper adapter 111 may further be used to connect a pin-type wiper arm 165 to the windshield wiper structure according to the principles of the present invention (see FIGS. 15 and 16).

It should be apparent from the foregoing that an invention having significant advantages has been provided. While the invention is shown in only a few of its forms, it is not just limited but is susceptible to various changes and modifications without departing from the spirit thereof.

We claim:

1. A windshield wiper structure comprising:
a supporting member including two elongated arc sheets parallel to each other and a guiding slot formed between the two elongated arc sheets;
a connection bracket straddled on a predetermined surface of the supporting member; and
a wiper strip engaged with the supporting member;
wherein the connection bracket has a base, two parallel plates extending upwardly from two lateral sides of the base respectively, a bar over the base and connected between the two parallel plates, and a clip member extending inwardly from each lateral side of a bottom of the base in order to clasp the lower surface of the supporting member.

2. The windshield wiper structure as claimed in claim 1, wherein the supporting member includes two secure members disposed at two ends thereof respectively, each secure member connects the two elongated arc sheets together.

3. The windshield wiper structure as claimed in claim 1, wherein the wiper strip has an orientation portion and a scrape portion connecting the orientation portion, the orientation portion has a sliding gap formed along each lateral side thereof for mating with the guiding slot of the supporting member.

4. The windshield wiper structure as claimed in claim 3, wherein the base of the connection bracket has an indentation formed of the bottom thereof for mating the orientation portion.

5. The windshield wiper structure as claimed in claim 3, wherein the scrape portion of the wiper strip is an elongated strip that has a rhombus configuration, so as to form a wedge notch between the orientation portion and the scrape portion.

6. The windshield wiper structure as claimed in claim 1, wherein the bar of the connection bracket is detachable.

7. The windshield wiper structure as claimed in claim 1, wherein the bar of the connection bracket is connected to the two parallel plates integrally in one piece.

8. The windshield wiper structure as claimed in claim 1, wherein the lower surface of the supporting member has an indent, and the clip member of the connection bracket has a bulge mating with the indent for secure connection.

9. The windshield wiper structure as claimed in claim 1, wherein the clip member of the connection bracket has an indent, and the lower surface of the supporting member has a bulge mating with the indent for secure connection.

10. The windshield wiper structure as claimed in claim 1, wherein each of the two parallel plates of the connection bracket has at least one through hole, each of the two parallel plates of the connection bracket has at least one through hole.

11. The windshield wiper structure as claimed in claim 1, further including two resilient strips straddled on the predetermined surface of the supporting member, wherein the connection bracket is disposed between the two resilient strips.

12. The windshield wiper structure as claimed in claim 11, further including two sleeve portions straddled on two ends of the predetermined surface of the supporting member and clamps the two resilient strips respectively to the supporting member.

13. The windshield wiper structure as claimed in claim 11, further including a cover member protecting the connection bracket and the two resilient strips respectively.

14. The windshield wiper structure as claimed in claim 13, wherein the base has a snap recess formed on each lateral side thereof, and the cover member has a snap tab formed on an inner surface of each lateral side for mating with the snap recess.
